(19) United States
(12) Patent Application Publication
(10) Pub. No.: US 2004/0204274 A1
(43) Pub. Date: Oct. 14, 2004

(54) Asymmetric sprocket assembly with metal cushion rings

(76) Inventor: James D. Young, Chesaning, MI (US)

Correspondence Address: FAY, SHARPE, FAGAN, MINNICH & McKEE, LLP, Seventh Floor, 1100 Superior Avenue, Cleveland, OH, 44114-2518, US

(21) Appl. No.: 10/740,777

(22) Filed: Dec. 19, 2003

Related U.S. Application Data
(60) Provisional application No. 60/435,555, filed on Dec. 19, 2002.

(51) Int. Cl. F16H 7/18; F16H 55/12; F16H 55/30

(52) U.S. Cl. 474/156; 474/152; 474/160; 474/100

(57) ABSTRACT

A sprocket assembly includes a sprocket body comprising: (i) first and second hubs that project axially outward from opposite first and second axial faces; and, (ii) a plurality of teeth that extend circumferentially in a row and that project radially outward between the first and second hubs. Each of the teeth includes a drive flank and a coast flank. The drive flank and coast flank of at least some of the teeth are shaped differently from each other so as to define an asymmetric tooth profile. First and second metal cushion rings are captured and float eccentrically on the first and second hubs, respectively. The teeth are identical or multiple asymmetric tooth profiles are used on a single sprocket body and arranged in a regular or irregular pattern. The root surface between successive teeth can be relieved so that a space is defined between the root surface and a roller that bridges the root.

### CROSS-REFERENCE TO RELATED APPLICATION

This application claims priority from and benefit of the filing date of U.S. provisional patent application No. 60/435,555 filed Dec. 19, 2002.

### BACKGROUND

FIGS. 1, 2A and 2B illustrate a conventional sprocket assembly S including a sprocket body 10, circular metal cushion rings 12a,12b positioned respectively adjacent first and second axial faces 14a,14b of a sprocket body 10. The sprocket body 10 defines a bore B or other recess about a central axis of rotation L, and first and second hubs 16a,16b project axially outward in opposite directions from the first and second faces 14a,14b, respectively. The hubs 16a,16b each define a cylindrical outer diameter that is centered on the axis L and that is received within the inner diameter of each of the rings 12a,12b. The inner diameter of the rings 12a,12b is larger than the outer diameter of the hubs 16a,16b so that the rings 12a,12b are able to float eccentrically thereon.

First and second flanges 18a,18b are respectively secured via welding or otherwise to the first and second hubs 16a,16b and capture the first and second rings 12a,12b on the first and second hubs, while still allowing the eccentric floating movement of the rings 12a,12b on the outer diameter of the hubs. The sprocket body 10 further comprises a plurality of teeth 20 defined therein and separated from each other by tooth spaces 22. Each tooth 20 includes an “engaging” or “drive” flank 24 and a “disengaging” or “coast” flank 26, with the drive flank 24 being downstream relative to the coast flank 26 in terms of the direction in which the sprocket rotates (see arrow 11). As such, the tooth spaces 22 are defined between circumferentially successive drive and coast flanks 24,26.

In conventional sprocket assemblies with metal cushion rings 12a,12b of the type being described, such as the sprocket assembly S, teeth 20 and tooth spaces 22 of the sprocket body 10 are purely symmetrical in configuration. More particularly, known sprocket assemblies S with metal cushion rings 12a,12b have included all identical teeth 20, and all of these identical teeth 20 have been defined by drive and coast flanks 24,26 that are symmetrical relative to each other, i.e., the flank 26 is a mirror image of the flank 24. For example, the sprocket body 10 and teeth 20 thereof are commonly defined in accordance with the ISO-606 standard as is well-known in the art.

The prior sprocket bodies 10 are defined from any suitable material such as steel or other metal, typically as a one-piece construction by powdered metal techniques, casting or machining or can be fabricated from separate components that are welded or otherwise secured together. The rings 12a,12b are typically defined from a suitable metal such as bearing-grade steel.

As is well known, the cushion rings 12a,12b buffer or soften the impact of chain links of an associated roller or bush chain as the relevant portions of the chain mesh with the sprocket S. During onset of meshing, the links of the chain contact and lay on the outer surface of the rings 12a,12b, and the rings 12a,12b gradually move to a position that allows the chain rollers to mesh fully with the sprocket teeth 20. Sprocket assemblies. S as described are typically used in automotive chain drive systems such as timing and/or balance drive systems.

### SUMMARY

In accordance with the present development, a sprocket assembly comprises a sprocket body including: (i) first and second hubs that project axially outward from opposite first and second axial faces; and, (ii) a plurality of teeth that extend circumferentially in a row and that project radially outward between the first and second hubs. Each of the teeth includes a drive flank and a coast flank, and the drive flank and coast flank of at least some of the teeth are shaped differently from each other so as to define an asymmetric tooth profile. First and second metal cushion rings are captured and float eccentrically on the first and second hubs, respectively.

A sprocket assembly formed in accordance with the present invention exhibits improved (reduced) noise and vibration characteristics when operatively meshed with an associated chain in an automotive timing system.

### BRIEF DESCRIPTION OF DRAWINGS

The invention comprises various components and arrangements of components, preferred embodiments of which are illustrated in the accompanying drawings wherein:

FIG. 1 is an isometric view of a conventional (non-asymmetric) sprocket assembly with metal cushion rings;

FIG. 2A is an exploded isometric view of the sprocket shown in FIG. 1;

FIG. 2B is similar to FIG. 2A but shows the opposite side of the sprocket assembly;

FIG. 3 is a partial front elevational view of a chain drive system comprising a roller chain meshing with an asymmetric sprocket assembly with metal cushion rings formed in accordance with the present development;

FIGS. 3A and 3B are isometric views of opposite axial faces of the asymmetric sprocket assembly of FIG. 3;

FIG. 4A is a front elevational view that shows the chain drive system of FIG. 3, with portions of the sprocket assembly broken away;

FIG. 4B is a rear elevational view that shows the chain drive system of FIG. 3, with portions of the sprocket assembly broken away;

FIG. 5 is another view of the chain drive system of FIG. 3, with the entire flange 118a and certain chain link plates removed to reveal the action of the cushion ring 112a (portions of the sprocket body that would ordinarily be hidden by the chain are shown in solid lines to aid in understanding operation of the development);

FIG. 6 is a greatly enlarged partial view corresponding to region 6 of FIG. 5;

FIG. 7 is a partial view of a sprocket body of an asymmetric sprocket assembly with metal cushion rings formed in accordance with an alternative embodiment; and,

FIG. 8 is a partial view of a sprocket body used as part of an asymmetric sprocket assembly formed in accordance with an alternative embodiment.

### DETAILED DESCRIPTION OF THE INVENTION

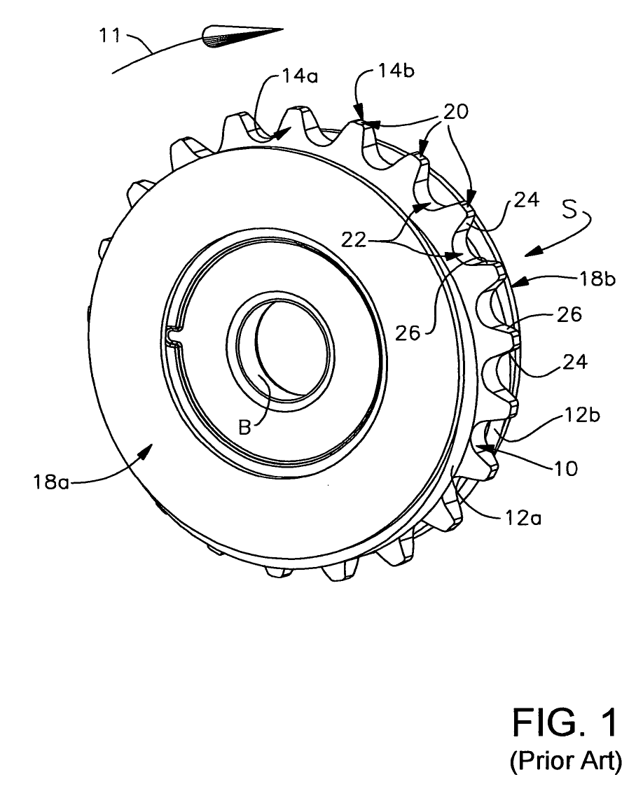

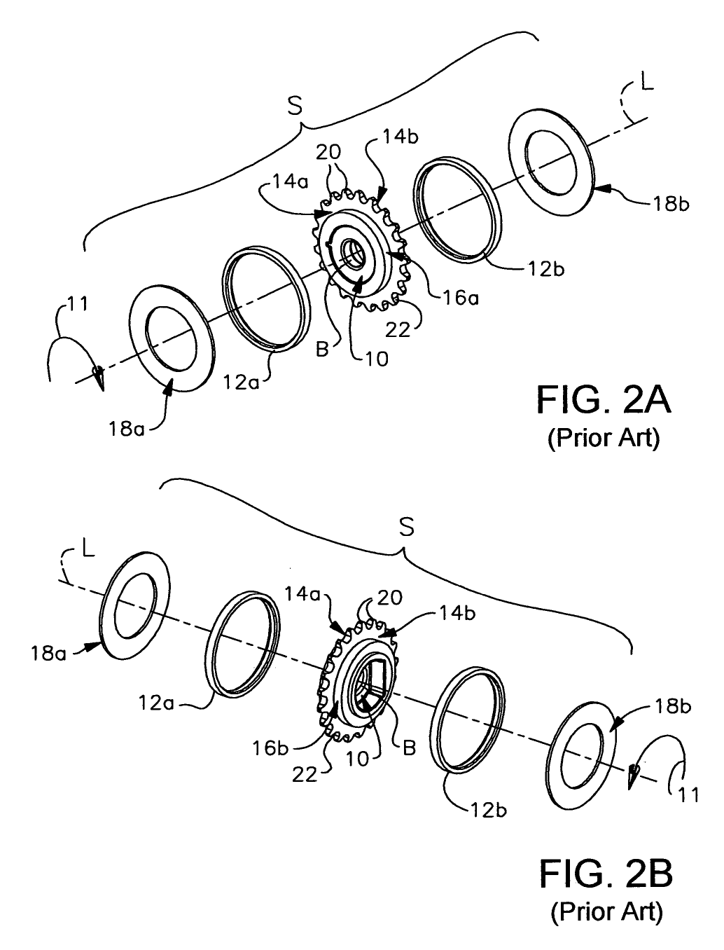

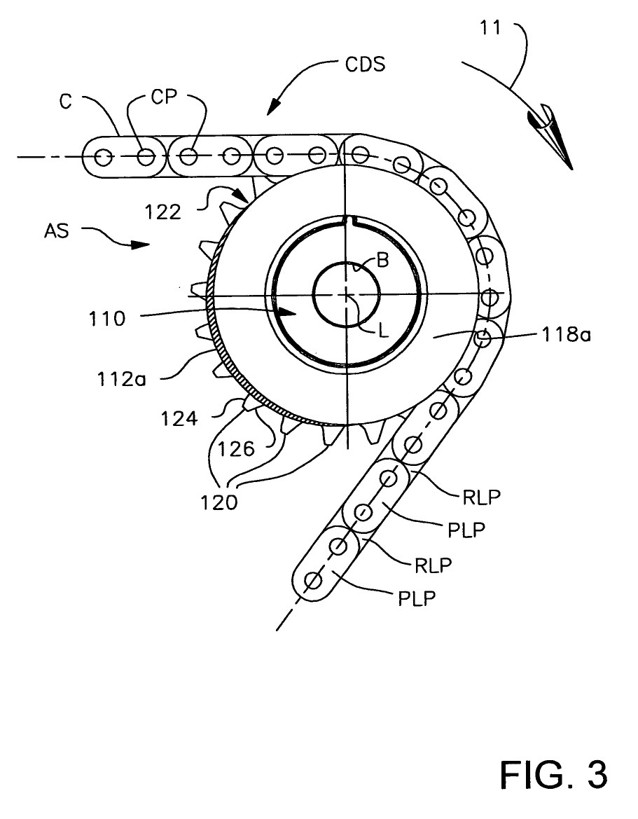

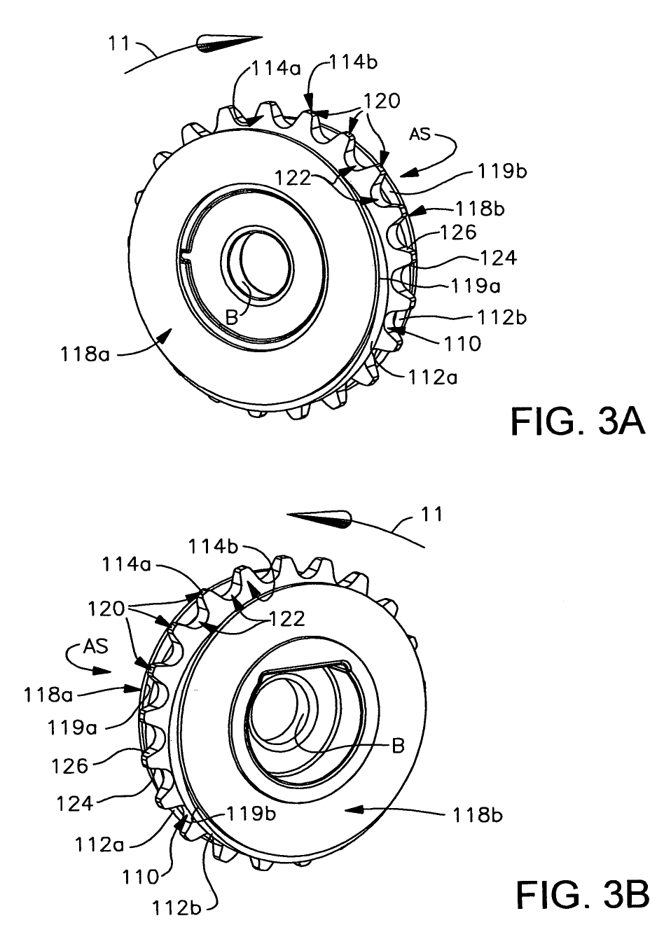

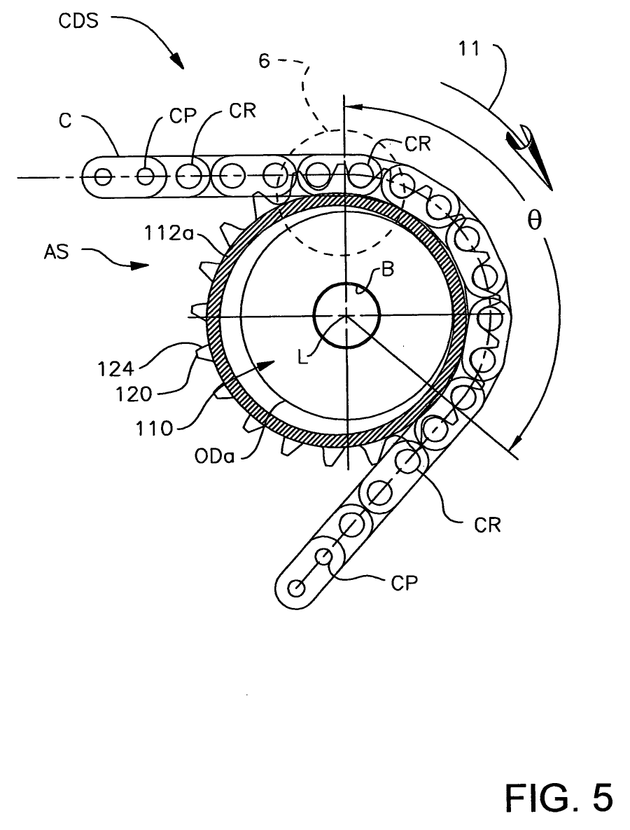

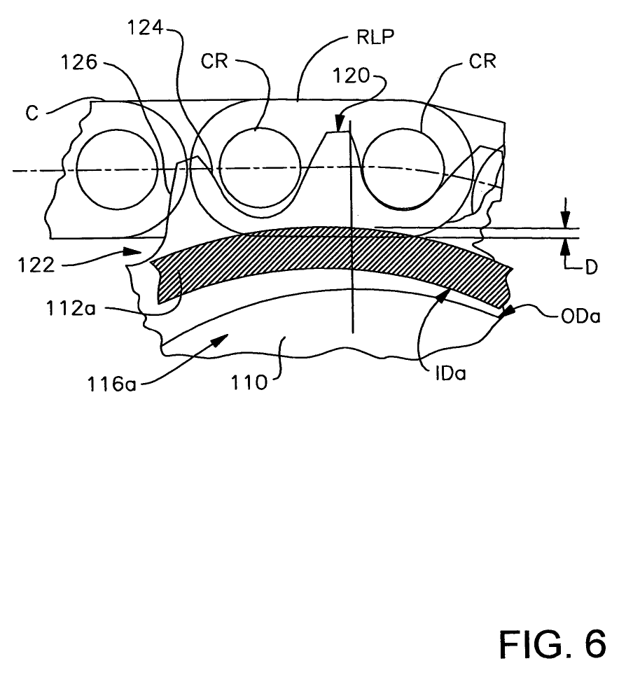

FIGS. 3-7 illustrate a sprocket assembly AS formed in accordance with the present invention as part of a chain drive system CDS such as an automotive timing or balance drive system or the like. The chain drive system CDS comprises the sprocket assembly AS and a chain C which is shown herein as a roller chain but can also be a bush chain. As is well known, the chain C comprises pins CP, rollers CR (see FIGS. 5 and 6 where certain links are removed to show the rollers) supported by the pins CP, roller link plates RLP and pin link plates PLP. The sprocket assembly AS can be either a drive sprocket or a driven sprocket and, except as otherwise shown and/or described, is identical to the sprocket assembly S disclosed above with reference to FIGS. 1, 2A and 2B.

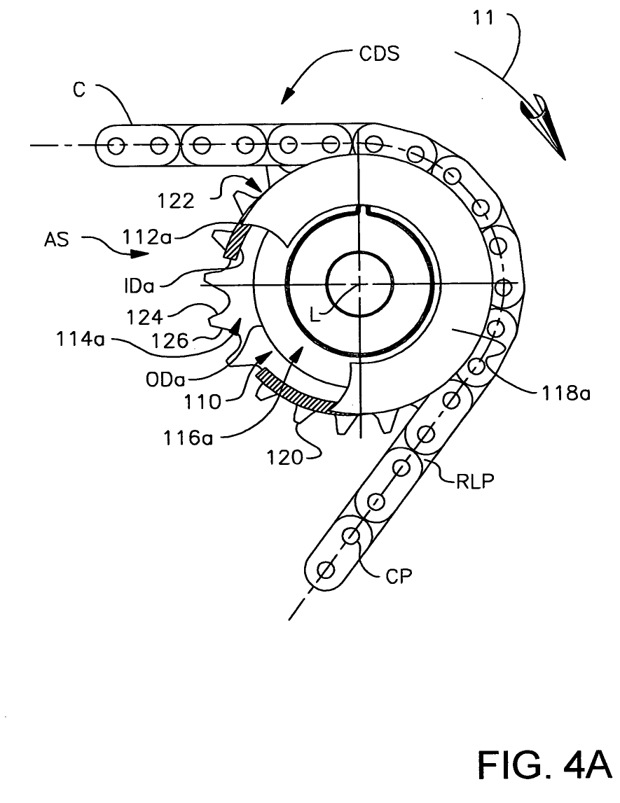

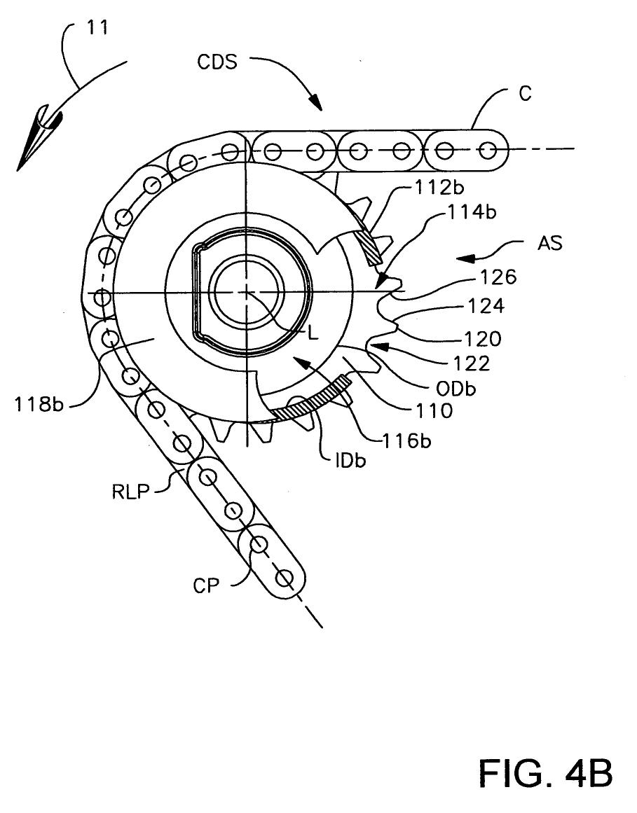

The sprocket assembly AS comprises sprocket body 110, and first and second metal cushion rings 112a,112b are positioned respectively adjacent first and second axial faces 114a,114b (see also FIG. 4A) of a sprocket body 110. The sprocket body 110 includes a bore B or recess defined about a central axis of rotation L that receives a drive shaft or a driven shaft (not shown). The sprocket body 110 is defined from any suitable metal such as steel or the like. The body 110 is defined from a one-piece construction by compacted powdered metal techniques, casting, forging and/or machining or can be fabricated from separate components that are welded or otherwise secured together. The rings 112a, 12b are preferably defined from a suitable metal such as bearing-grade steel.

With particular reference to both FIGS. 4A and 4B, which show opposite axial faces of the sprocket assembly AS, it can be seen that first and second hubs 116a,116b project axially outwardly in opposite directions along the axis L from the first and second opposite sprocket body faces 114a,114b, respectively. The hubs 116a,116b define cylindrical outer diameters ODa,ODb that are centered on the axis L and that are received within the cylindrical inner diameters IDa,IDb of the rings 112a,112b, respectively (the flanges 118a,118b, which are described in further detail below, and the rings 112a, 112b are partially broken away to reveal the sprocket body 110). The inner diameter IDa,IDb of the rings 112a,112b is larger than the outer diameter ODa,ODb of the hubs 116a,116b so that the rings 112a,112b eccentrically float on the respective first and second hubs 116a,116b while axially captured in grooves defined between the flanges 118a,118b and sprocket faces 114a,114b, respectively.

The first and second flanges 118a,118b are radially enlarged relative to the hubs 116a,116b and are respectively secured via welding or otherwise to, or are defined as a one-piece construction with, the first and second hubs 116a,116b and capture the first and second rings 112a,112b on the first and second hubs 116a,116b, while still allowing the eccentric floating movement of the rings 112a,112b on the outer diameter ODa,ODb of the respective hubs 116a,116b. In other words, annular channels 119a,119b are defined respectively between the flanges 118a,118b and faces 114a,114b, and the rings 112a,112b are located in these channels, respectively.

As best seen in FIGS. 4A and 4B, the sprocket body 110 further comprises or defines a plurality of teeth 120 that extend circumferentially around the body 110 in a row and that project radially outward therefrom axially between hubs 116a,116b. Tooth spaces 122 are defined circumferentially between successive teeth 120. Each tooth includes an “engaging” or “drive” flank 124 and a “disengaging” or “coast”-flank 126, with the drive flank 124 being downstream relative to (ahead of) the coast flank 126 in terms of the direction in which the sprocket assembly AS rotates as shown by arrow 11. As such, the tooth spaces 122 are defined between circumferentially successive drive and coast flanks 124,126.

Unlike conventional sprocket assemblies S as described above in connection with FIGS. 1, 2A and 2B, at least a plurality and preferably all of the teeth 120 and tooth spaces 122 of the sprocket AS are asymmetric to reduce noise and vibration associated with the meshing impacts of the chain rollers CR with the sprocket teeth 120. More particularly, at least a plurality of the teeth 120 are defined by drive and coast flanks 124,126 that are non-symmetrical relative to each other, i.e., the flank 126 is shaped differently from (i.e., not a mirror image of) the flank 124 for at least one and preferably all the teeth 120. Furthermore, all teeth 120 can be identical to each other or, alternatively, some of the teeth 120 can be different from the others and arranged in a regular or an irregular or “random” patterns on the sprocket body 110 in order to modulate the frequency of impacts between the chain rollers CR and sprocket teeth 120.

The teeth 120 and tooth spaces 122 are formed to have any suitable shape that results in asymmetric (i.e., differently shaped) flanks 124,126, and it is preferred that the engaging flank 124 be steeper than the disengaging flank 126 as shown so that the chain rollers CR make tangential impact with the engaging flank 124 at onset of meshing before seating in relevant tooth space 122. The flanks 124,126 are defined by circular arc sections or involutes and optionally include flats or other features to reduce noise and vibration. Examples of suitable preferred profiles for asymmetric teeth 120 and tooth spaces 122 are found in the following U.S. patent documents, and the disclosures of all of same are hereby expressly incorporated by reference herein: (i) U.S. Pat. No. 6,371,875; (ii) U.S. Pat. No. 6,325,734; (iii) U.S. Pat. No. 6,179,741; (iv) U.S. Pat. No. 6.090,003; (v) U.S. Pat. No. 5,997,424; (vi) U.S. Pat. No. 5,993,344; (vii) U.S. Pat. No. 5,976,045; (viii) U.S. Pat. No. 5,921,879; (ix) U.S. Pat. No. 5,921,878; and, (x) U.S. Pat. No. 5,876,295.

FIG. 8 shows a sprocket body 210 that that can be used in place of the sprocket body 110 to define the sprocket assembly AS. The sprocket body 210 is identical to the sprocket body 110 except that it comprises a combination of different suitable asymmetric teeth 120a,120b arranged in a regular or irregular, random pattern relative to each other about the sprocket. Of the foregoing patent documents, at least U.S. Pat. Nos. 5,921,879; 5,976,045; 6,090,003; 5,997,424; 6,179,741 disclose asymmetric sprockets having different asymmetric teeth arranged on a single sprocket in a regular or irregular, random pattern in a manner suitable for use as the teeth 120 of the sprocket body 110 to thus define a sprocket body 210. Such an arrangement of differently shaped asymmetric teeth 120a,120b serves to modulate the frequency of initial impacts between the rollers CR of chain C and the teeth 120 of sprocket body 110 as the chain C meshes with sprocket body 110 which serves to reduce noise and vibration.

FIGS. 5 and 6 illustrate operation of the sprocket assembly AS (in both cases, chain links are removed and features that would ordinarily be hidden are shown in solid lines to facilitate an understanding of the development). It can be seen that certain rollers CR of the chain C that fall within the wrap angle e are fully seated in respective tooth spaces 120 while other rollers CR outside of the wrap are partially seated or completely unmeshed relative to the sprocket AS. The overall geometry of the chain drive system CDS determines the magnitude of the chain wrap angle Φ. As shown in FIG. 6, aligned pairs roller link plates RLP engage the rings 112a,112b on opposite axial sides of the teeth 120 as the rollers CR located between the plates RLP move into engagement with the teeth 120 (only the link plate RLP in the background is shown). The link pin link plates PLP and roller link plates RLP contact the outer surface of the rings 112a,112b and displace the rings 112a,112b radially a distance D between initial contact and full seating of the relevant rollers CR. As noted above, the rings 112a,112b dampen the impact between the rollers CR and the teeth 120 of the sprocket body 110 to reduce noise. As the wrap angle Φ increases, the outer diameter of each ring 112a,112b is decreased to control the radial displacement distance D that would otherwise increase with an increased wrap angle Φ.

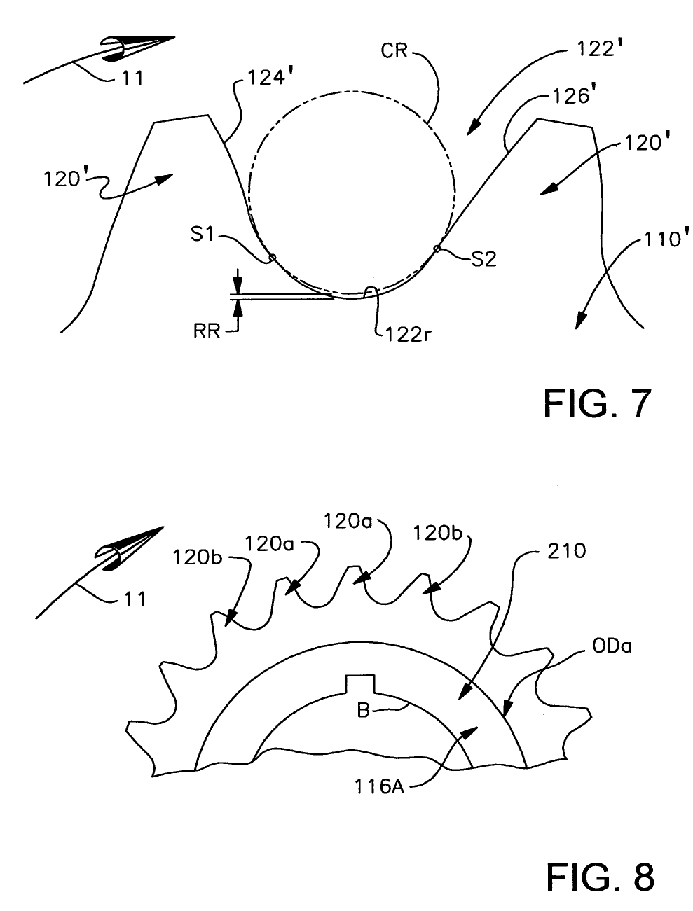

The sprocket assembly AS can optionally be constructed with an alternative sprocket body 110′ as shown in FIG. 7. Except as shown and/or described, the sprocket body 110′ is identical to the sprocket body 110 and, thus, like components are identified with like reference numerals including a primed (′) suffix. Unlike the sprocket 110, the tooth spaces 122′ defined between successive teeth 120′ of the sprocket body 110′ are defined with root relief, i.e., where the root surface 122r that is located between the engaging flank 124′ and disengaging flank 126′ is “relieved” so that a space RR is defined between the root surface 122r and a roller CR that is fully seated in the tooth space 122′ and bridging the root surface 122r while seated at locations S1,S2 of the engaging flank 124′ and disengaging flank 126′, respectively.

The invention has been described with reference to preferred embodiments. Modifications and alterations will occur to those of ordinary skill in the art to which the invention pertains, and it is intended that the invention be construed as encompassing all such modifications and alterations.

1. A sprocket assembly comprising:
a sprocket body comprising: (i) first and second hubs that project axially outward from opposite first and second axial faces; and, (ii) a plurality of teeth that extend circumferentially in a row and that project radially outward between said first and second hubs, wherein each of said teeth includes a drive flank and a coast flank, and wherein said drive flank and said coast flank of at least some of said teeth are shaped differently from each other so as to define an asymmetric tooth profile;
first and second metal cushion rings captured and floating eccentrically on said first and second hubs, respectively.

2. The sprocket assembly as set forth in claim 1, wherein said first and second hubs comprise cylindrical outer diameters and wherein said first and second metal cushion rings define cylindrical inner diameters, and wherein: (i) said inner diameter of said first cushion ring is larger than the outer diameter of said first hub; and, (ii) said inner diameter of said second cushion ring is larger than the outer diameter of said second hub.

3. The sprocket assembly as set forth in claim 1, wherein said sprocket body further comprises first and second flanges that project outwardly from said first and second hubs, respectively, wherein said first flange axially captures said first cushion ring on said first hub and said second flange axially captures said second cushion ring on said second hub.

4. The sprocket assembly as set forth in claim 3, wherein first and second annular channels are defined respectively between said first and second flanges and said first and second axial faces, wherein said first and second cushion rings are located in said first and second annular channels.

5. The sprocket assembly as set forth in claim 4, wherein said first and second flanges are connected to said first and second hubs by welding.

6. The sprocket assembly as set forth in claim 5, wherein said sprocket body is defined as a one-piece construction.

7. The sprocket assembly as set forth in claim 6, wherein said sprocket body is defined as from compacted powdered metal.

8. The sprocket assembly as set forth in claim 3, wherein said sprocket body further comprises a bore or recess adapted to receive an associated shaft.

9. The sprocket assembly as set forth in claim 1, wherein all of said plurality of teeth are identical to each other.

10. The sprocket assembly as set forth in claim 1, wherein said teeth comprise at least a first set of teeth having a first asymmetric tooth profile and a second set of teeth having a second asymmetric tooth profile that is different from said first asymmetric tooth profile.

11. The sprocket as set forth in claim 10, wherein said first and second sets of teeth are arranged in an irregular pattern.

12. The sprocket assembly as set forth in claim 1, wherein said drive flank of said asymmetric tooth profile is steeper than said coast flank of said asymmetric tooth profile.

13. The sprocket assembly as set forth in claim 12, wherein said sprocket body comprises a root surface located between each successive pair of said plurality of teeth, wherein said root surface is relieved so that a space is defined between said root surface and an associated roller when the associated roller is seated in contact with the drive flank of one tooth of said pair and the coast flank of the other tooth of said pair.

14. The sprocket assembly as set forth in claim 1, further comprising a roller chain drivingly engaged therewith.
